(19) United States
(12) Patent Application Publication
(10) Pub. No.: US 2018/0211246 A1
(43) Pub. Date: Jul. 26, 2018

(54) Document Printing System That Includes Online Payment Service, Image Forming Apparatus, and Electronic Device Having Web Browser

(71) Applicant: Kyocera Document Solutions Inc., Osaka (JP)

(72) Inventors: Zhenyu Sun, Osaka (JP); Yumi Nakagoshi, Osaka (JP); Tatsuya Hiwatari, Osaka (JP)

(21) Appl. No.: 15/878,442

(22) Filed: Jan. 24, 2018

(30) Foreign Application Priority Data
Jan. 24, 2017 (JP) 2017-009982

(51) Int. Cl. G06Q 20/32; G06Q 20/18; H04N 1/34; G06F 3/12

(52) U.S. Cl. CPC G06Q 20/3276; G06Q 20/18; H04N 1/34; H04N 2201/0094; G06F 3/1272; G06F 3/1205; G06F 3/1292

(57) ABSTRACT

A document printing system includes an image forming apparatus, an electronic device, a print-data generating unit, a charge calculator, and a payment code notification unit. The image forming apparatus includes a document accepting unit that accepts a document via a web page. The charge calculator calculates a charge based on the document accepted by the document accepting unit. The payment code notification unit notifies a payment code issued by an online payment service to the charge. The image forming apparatus includes a document printing unit that executes a print job with the print device based on the print data when the charge has been paid via the online payment service using the payment code notified by the payment code notification unit. The electronic device includes a document transmitting application to transmit the document. The web browser transmits the document to the image forming apparatus via the document transmitting application.

### INCORPORATION BY REFERENCE

This application is based upon, and claims the benefit of priority from, corresponding Japanese Patent Application No. 2017-009982, filed in the Japanese Patent Office on Jan. 24, 2017, and the entire contents of which are incorporated herein by reference.

### BACKGROUND

Unless otherwise indicated herein, the description in this section is not prior art to the claims in this application and is not admitted to be prior art by inclusion in this section.

There has been known a typical system that includes a coin vendor, which ensures a payment for a charge by cash, and a copier. The system executes the real-time payment for the charge by the coin vendor at execution of a copy job by the copier.

### SUMMARY

A document printing system according to one aspect of the disclosure includes an image forming apparatus, an electronic device, a print-data generating unit, a charge calculator, and a payment code notification unit. The image forming apparatus includes a print device and a document accepting unit that accepts a document via a web page. The electronic device includes a web browser to display the web page. The print-data generating unit generates print data of the document accepted by the document accepting unit. The charge calculator calculates a charge based on the document accepted by the document accepting unit. The payment code notification unit notifies a payment code issued by an online payment service to the charge calculated by the charge calculator. The image forming apparatus includes a document printing unit that executes a print job with the print device based on the print data when the charge has been paid via the online payment service using the payment code notified by the payment code notification unit. The electronic device includes a document transmitting application to transmit the document. The web browser transmits the document to the image forming apparatus via the document transmitting application.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 is a block diagram illustrating a document printing system according to one embodiment of the disclosure.

FIG. 2 is a block diagram illustrating a user terminal according to the one embodiment.

FIG. 3 is a block diagram illustrating an electronic device according to the one embodiment.

FIG. 4 is a block diagram illustrating an MFP according to the one embodiment.

FIG. 5 illustrates exemplary document management information illustrated in FIG. 4.

FIG. 6 is a block diagram illustrating a computer according to the one embodiment.

FIG. 7 illustrates exemplary MFP management information illustrated in FIG. 6.

FIG. 8 illustrates exemplary payment code management information illustrated in FIG. 6.

FIG. 9 illustrates exemplary information stored by an online payment service according to the one embodiment.

FIG. 10 illustrates exemplary payment code management information illustrated in FIG. 9.

FIG. 11 illustrates an operation of the document printing system according to the one embodiment when a new document is stored in the MFP.

FIG. 12 illustrates an operation of the document printing system according to the one embodiment until the MFP to which an instruction of an execution of a document print job has been input displays a two-dimensional code.

FIG. 13 illustrates an operation of the document printing system according to the one embodiment from when the user terminal reads the two-dimensional code until the MFP terminates the execution of the document print job.

FIG. 14 illustrates an exemplary payment screen displayed on a display of the user terminal according to the one embodiment.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes one embodiment of the disclosure by referring to the drawings.

First, a description will be given of a configuration of a document printing system according to the embodiment.

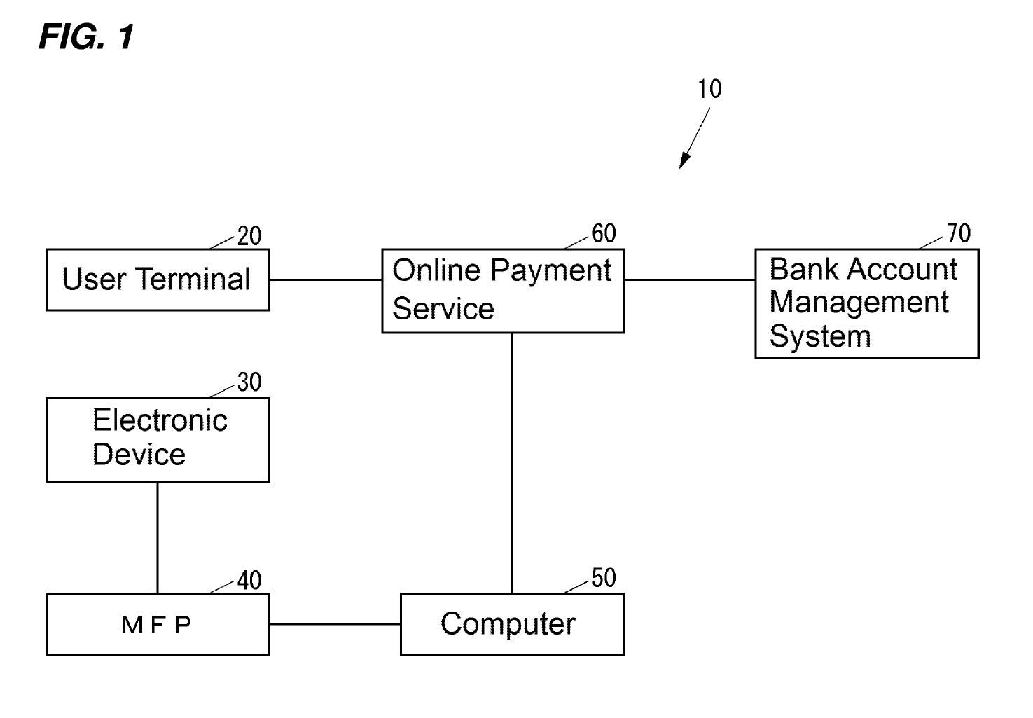

FIG. 1 is a block diagram illustrating a document printing system 10 according to the embodiment.

As illustrated in FIG. 1, the document printing system 10 includes a user terminal 20 used by a user, an electronic device 30 used by a user, a multifunction peripheral (MFP) 40 as an image forming apparatus, a computer 50, an online payment service 60 as a cloud service that executes online payments, and a bank account management system 70 that manages bank accounts.

The MFP 40 is installable at various facilities, for example, commercial facilities such as a convenience store and an eating place, and public facilities such as a university. The MFP 40 is a device that executes a print job of a document accepted from the electronic device 30 corresponding to a payment for a charge by the user.

In addition to the process regarding the charge of the MFP 40, the computer 50 may be configured to execute a process regarding a charge of at least one MFP similar to the MFP 40.

The online payment service 60 and the bank account management system 70 are cloud services and are systems achieved by servers such as cloud servers.

The user terminal 20 and the online payment service 60 are communicable via a network such as the Internet.

The electronic device 30 and the MFP 40 are configured to execute wireless communication directly (hereinafter referred to as “direct wireless communication”) without being via another communication device such as a router. The direct wireless communication is, for example, Wi-Fi Direct (registered trademark).

The MFP 40 and the computer 50 are communicable via a network such as a local area network (LAN) or the Internet, or directly communicable without being via the network, by wired or wireless communications.

The computer 50 and the online payment service 60 are communicable via the network such as the Internet.

The online payment service 60 and the bank account management system 70 are communicable via the network such as the Internet.

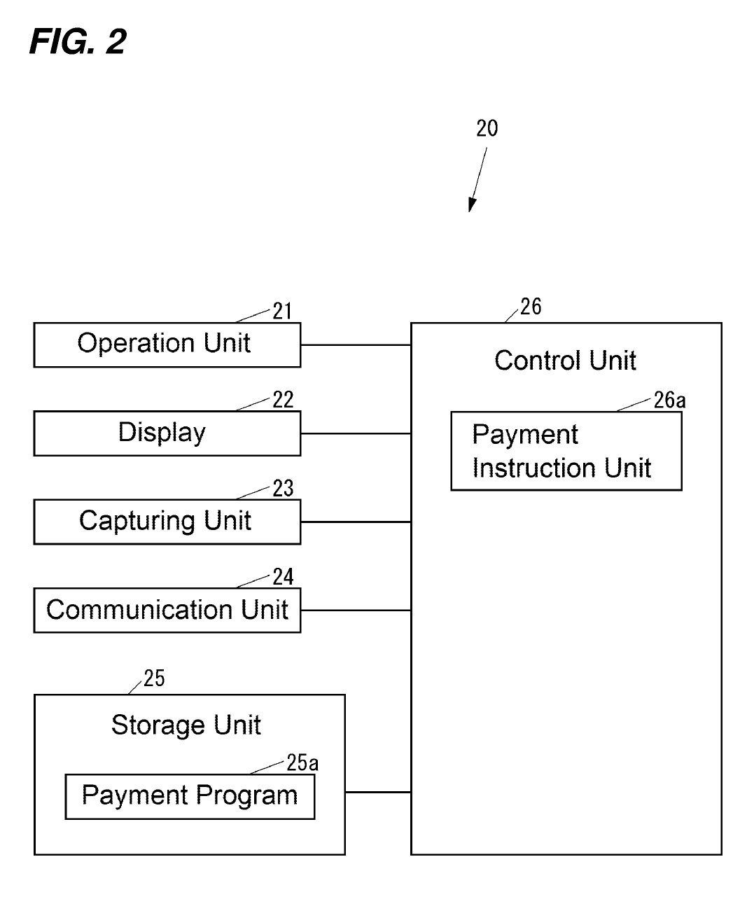

FIG. 2 is a block diagram illustrating the user terminal 20.

As illustrated in FIG. 2, the user terminal 20 includes an operation unit 21, a display 22, a capturing unit 23, a communication unit 24, a storage unit 25, and a control unit 26. The operation unit 21 is an input device such as a button through which various operations are input. The display 22 is a display device such as a liquid crystal display (LCD) that displays various kinds of information. The capturing unit 23 is a capturing device such as a camera. The communication unit 24 is a communication device that executes communications with an external device via the network or directly without being via the network by the wired or wireless communications. The storage unit 25 is a nonvolatile storage device such as a semiconductor memory that stores various pieces of information. The control unit 26 controls the entire user terminal 20. The user terminal 20 may be a portable terminal such as a smart phone and a tablet.

The storage unit 25 stores a payment program 25a for payment by the online payment service 60 (see FIG. 1). The payment program 25a may be installed onto the user terminal 20 at a production stage of the user terminal 20, may be additionally installed from an external storage medium such as a universal serial bus (USB) memory to the user terminal 20, or may be additionally installed from the network to the user terminal 20.

The control unit 26 includes, for example, a central processing unit (CPU), a read-only memory (ROM) that stores programs and various data, and a random-access memory (RAM) used as a work area for the CPU. The CPU executes the programs stored in the ROM or the storage unit 25.

The control unit 26 executes the payment program 25a to achieve a payment instruction unit 26a that instructs the online payment service 60 to execute the payment.

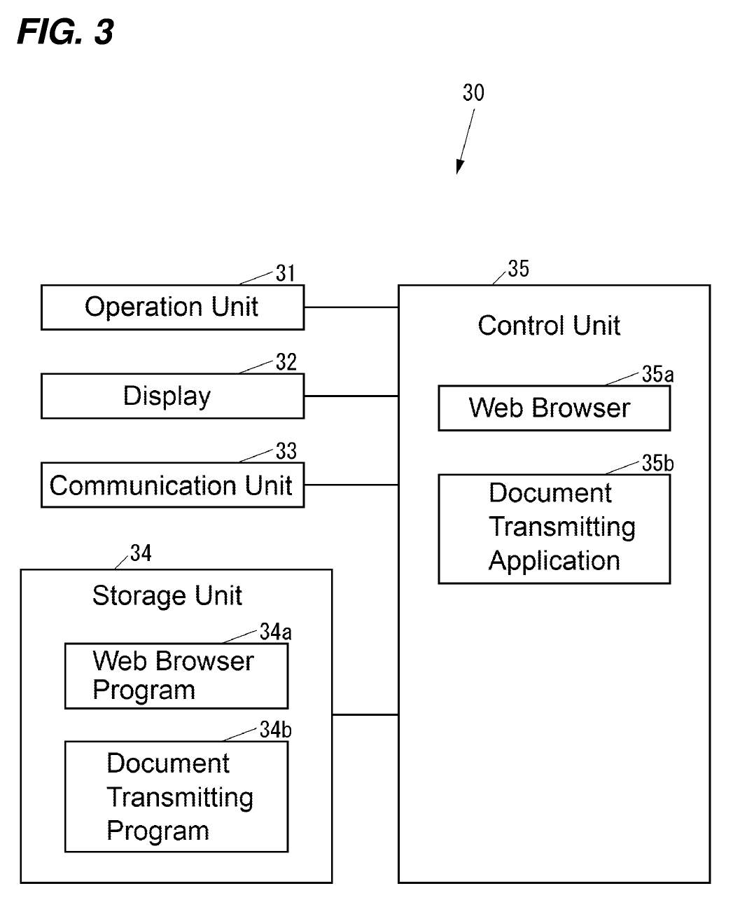

FIG. 3 is a block diagram illustrating the electronic device 30.

As illustrated in FIG. 3, the electronic device 30 includes an operation unit 31, a display 32, a communication unit 33, a storage unit 34, and a control unit 35. The operation unit 31 is an input device such as a keyboard and a computer mouse through which various operations are input. The display 32 is a display device such as the LCD that displays various kinds of information. The communication unit 33 is a communication device that executes communications with the external device via the network or directly without being via the network by the wired or wireless communications. The storage unit 34 is a nonvolatile storage device such as the semiconductor memory and a hard disk drive (an HDD) that stores various pieces of information. The control unit 35 controls the entire electronic device 30. The electronic device 30 may be configured of a portable terminal such as a laptop personal computer (PC), a smart phone, and a tablet.

The storage unit 34 stores a web browser program 34a and a document transmitting program 34b. Each of the web browser program 34a and the document transmitting program 34b may be installed onto the electronic device 30 at a production stage of the electronic device 30, may be additionally installed from an external storage medium such as the USB flash drive, a compact disk (CD), and a digital versatile disk (DVD) to the electronic device 30, or may be additionally installed from the network to the electronic device 30.

The control unit 35 includes, for example, the CPU, the ROM that stores programs and various data, and the RAM used as the work area for the CPU. The CPU executes the programs stored in the ROM or the storage unit 34.

The control unit 35 executes the web browser program 34a to achieve a web browser 35a. The control unit 35 executes the document transmitting program 34b to achieve a document transmitting application 35b.

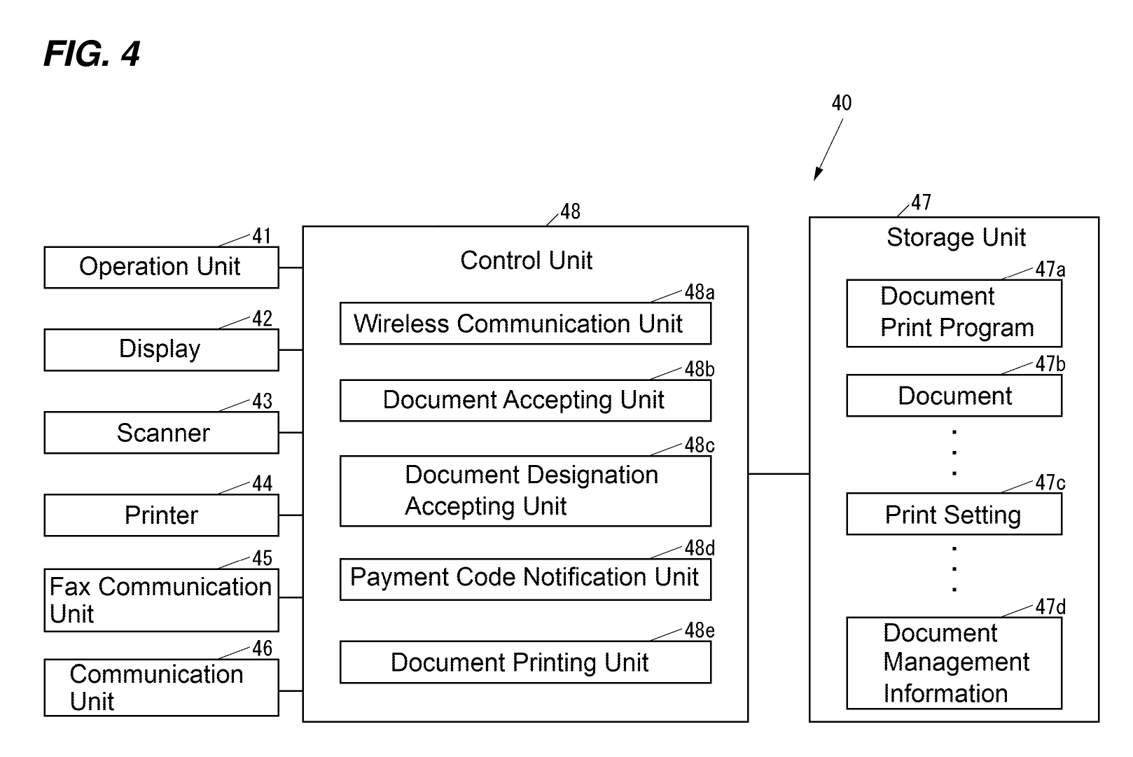

FIG. 4 is a block diagram illustrating the MFP 40.

As illustrated in FIG. 4, the MFP 40 includes an operation unit 41, a display 42, a scanner 43, a printer 44, a fax communication unit 45, a communication unit 46, a storage unit 47, and a control unit 48. The operation unit 41 is an input device such as a button through which various operations are input. The display 42 is a display device such as the LCD that displays various kinds of information. The scanner 43 is a reading device that reads an image from a document. The printer 44 is a print device that prints the image on the recording medium such as a paper sheet. The fax communication unit 45 is a fax device that executes fax communications with an external facsimile device (not illustrated) via a communication line such as a dial-up line. The communication unit 46 is a communication device that executes communications with the external device via the network or directly without being via the network by the wired or wireless communications. The storage unit 47 is a nonvolatile storage device such as the semiconductor memory and the HDD that store various pieces of information. The control unit 48 controls the entire MFP 40.

The storage unit 47 stores a document print program 47a for executing a document print job. The document print program 47a may be installed onto the MFP 40 at production stage of the MFP 40, may be additionally installed from an external storage medium such as the USB flash drive to the MFP 40, or may be additionally installed from the network to the MFP 40.

The storage unit 47 is configured to store a document 47b. As the document 47b, documents of various formats, for example, a portable document format (PDF) document, a Microsoft (registered trademark) Word document, a Microsoft Excel (registered trademark) document, a Microsoft PowerPoint (registered trademark) document, a tagged image file format (TIFF) document, and a Joint Photographic Experts Group (JPEG) document are employable. The document 47b includes a print setting of the document 47b itself in some cases.

The storage unit 47 is configured to store a print setting 47c of the document 47b. The print setting 47c includes, for example, a setting of the number of copies to be printed, a setting of a size of a recording medium to be printed, a setting of any of a monochrome printing and a color printing, and a setting of any of a duplex printing and a single-side printing.

The storage unit 47 is configured to store document management information 47d for managing the document.

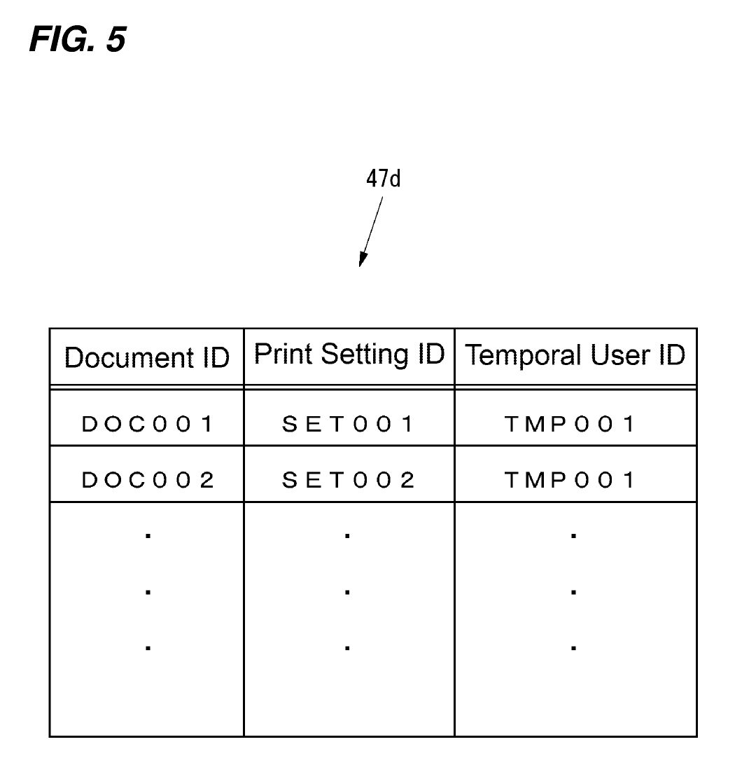

FIG. 5 illustrates exemplary document management information 47d.

As illustrated in FIG. 5, the document management information 47d is information where a document ID as identification information of the document 47b, a print setting ID as identification information of the print setting 47c, a name of a temporal user (hereinafter referred to as “a temporal user name”), and identification information (hereinafter referred to as “a temporal user ID”) such as a personal identification number (PIN) code are matched.

The control unit 48 illustrated in FIG. 4 includes, for example, the CPU, the ROM that stores the programs and various data, and the RAM used as the work area for the CPU. The CPU executes the programs stored in the ROM or the storage unit 47.

The control unit 48 executes the document print program 47a to achieve a wireless communication unit 48a, a document accepting unit 48b, a document designation accepting unit 48c, a payment code notification unit 48d, and a document printing unit 48e. The wireless communication unit 48a is configured to execute the direct wireless communication with the external electronic device. The document accepting unit 48b accepts the document 47b via the direct wireless communication executed by the wireless communication unit 48a. The document designation accepting unit 48c accepts a designation of the document 47b matched with the temporal user ID. The payment code notification unit 48d notifies the payment code issued to the charge, which is calculated by the computer 50 (see FIG. 1), by the online payment service 60 (see FIG. 1). The document printing unit 48e executes the print job by the printer 44 based on print data when the charge is paid using the payment code notified from the payment code notification unit 48d via the online payment service 60.

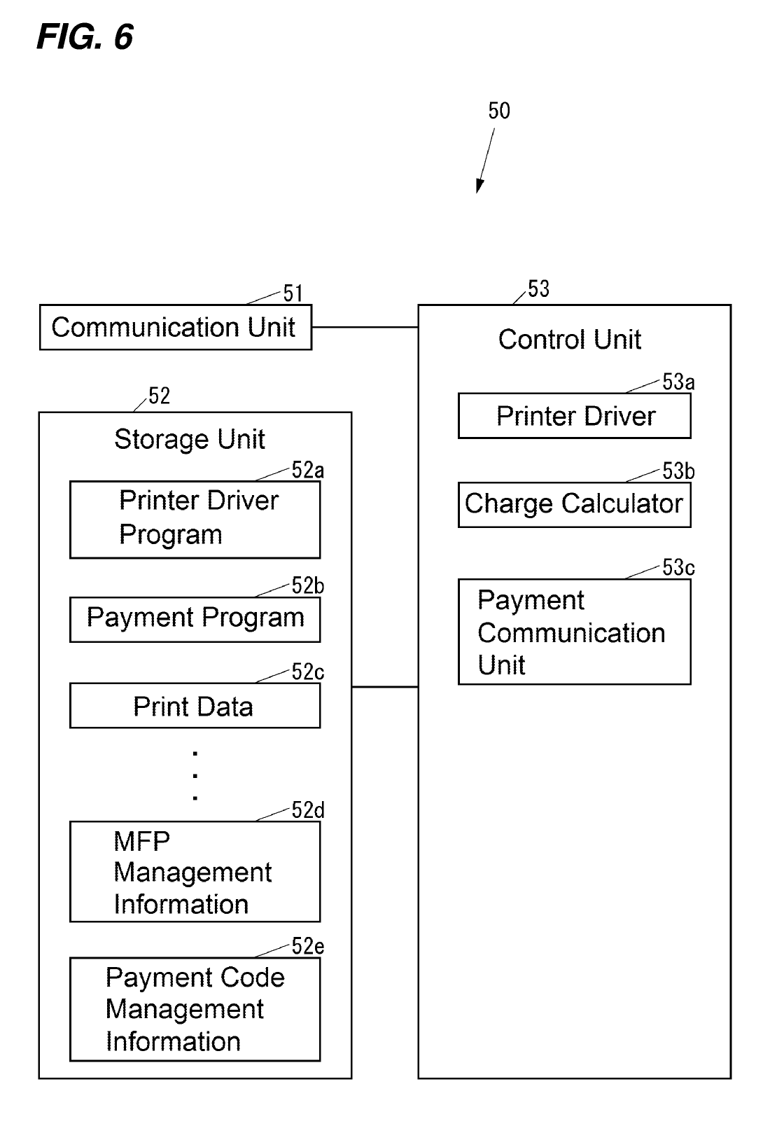

FIG. 6 is a block diagram illustrating the computer 50.

As illustrated in FIG. 6, the computer 50 includes a communication unit 51, a storage unit 52, and a control unit 53. The communication unit 51 is a communication device that executes communications with the external device via the network or directly without being via the network by the wired or wireless communications. The storage unit 52 is the nonvolatile storage device such as the semiconductor memory and the HDD that store various pieces of information. The control unit 53 controls the entire computer 50. The computer 50 may be configured of, for example, a PC.

The storage unit 52 stores a printer driver program 52a and a payment program 52b for payment by the online payment service 60 (see FIG. 1). Each of the printer driver program 52a and the payment program 52b may be installed onto the computer 50 at a production stage of the computer 50, may be additionally installed from an external storage medium such as the USB flash drive, the CD, and the DVD to the computer 50, or may be additionally installed from the network to the computer 50.

The storage unit 52 is configured to store print data 52c.

The storage unit 52 stores MFP management information 52d to manage the MFP.

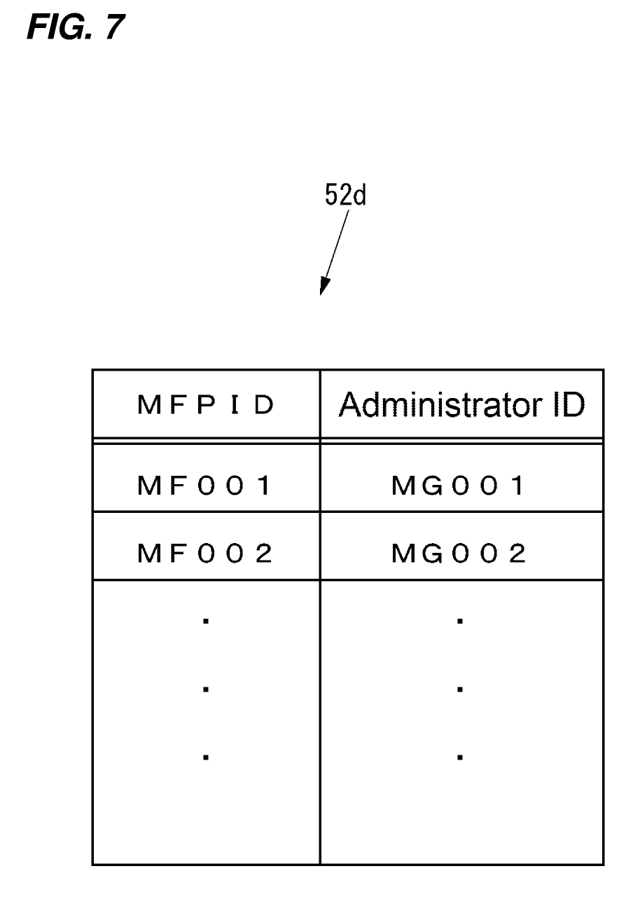

FIG. 7 illustrates the exemplary MFP management information 52d.

As illustrated in FIG. 7, the MFP management information 52d is information where MFP IDs as identification information of the MFPs are matched with administrator IDs as identification information of administrators of the MFPs.

As illustrated in FIG. 6, the storage unit 52 can store payment code management information 52e to manage the payment code issued by the online payment service 60 (see FIG. 1).

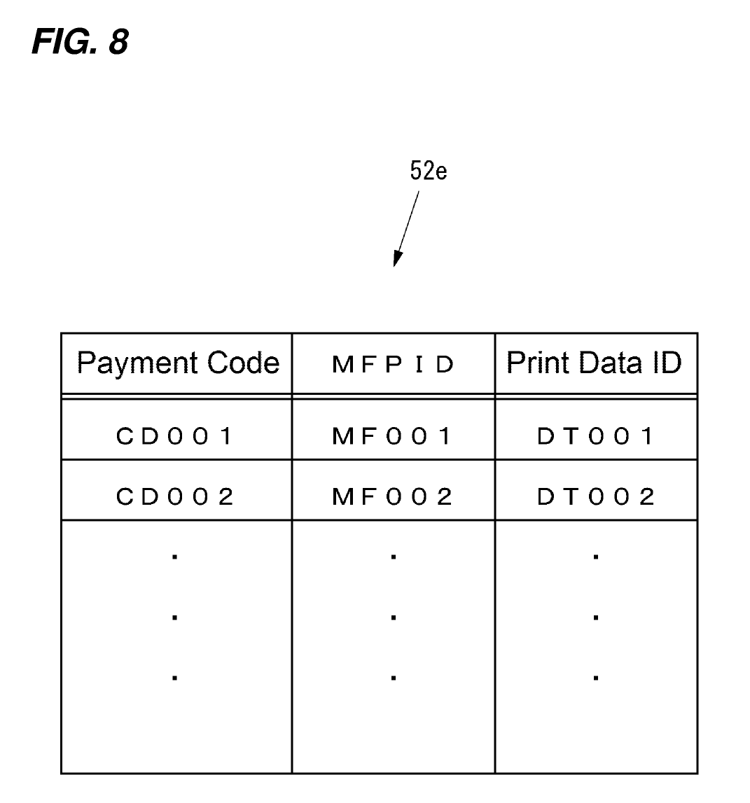

FIG. 8 illustrates the exemplary payment code management information 52e.

As illustrated in FIG. 8, the payment code management information 52e is information where the payment codes, the MFP IDs, and print data IDs as identification information of the print data 52c are matched.

The control unit 53 illustrated in FIG. 6 includes, for example, the CPU, the ROM that stores programs and various data, and the RAM used as the work area for the CPU. The CPU executes the programs stored in the ROM or the storage unit 52.

The control unit 53 executes the printer driver program 52a to achieve a printer driver 53a as a print-data generating unit that generates print data of a document.

The control unit 53 executes the payment program 52b to achieve a charge calculator 53b and a payment communication unit 53c. The charge calculator 53b calculates the charge based on the number of pages and print setting of the document. The payment communication unit 53c executes communications for the payment by the online payment service 60.

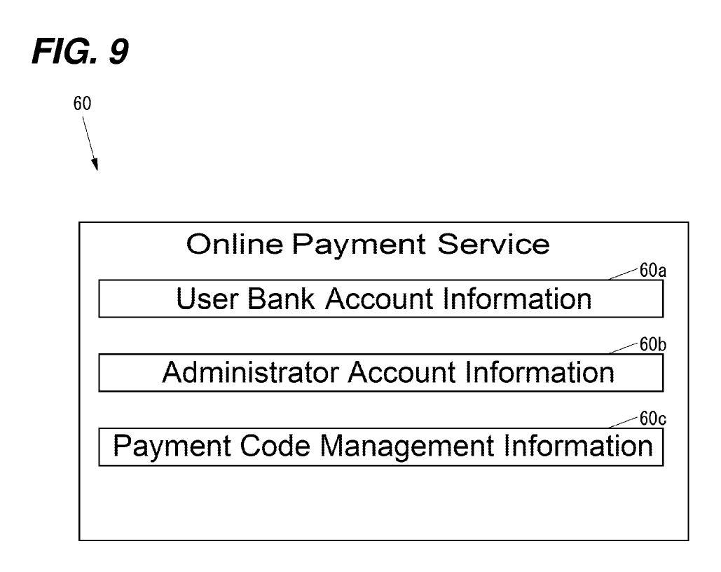

FIG. 9 illustrates exemplary information stored by the online payment service 60.

As illustrated in FIG. 9, the online payment service 60 stores user bank account information 60a and administrator account information 60b. The user bank account information 60a shows information on the bank account of the user for each user ID as the identification information of the user. The administrator account information 60b shows information on the account of the administrator of the MFP 40 for each administrator ID.

The user bank account information 60a includes information on the bank account of the user such as a name of the bank that manages the bank account of the user and the account number of the bank account. For example, the user can register the information on the bank account of the user on the user bank account information 60a in the online payment service 60 via the payment program 25a via the operation unit 21 of the user terminal 20.

For example, the administrator can register the information on the account of the administrator on the administrator account information 60b in the online payment service 60 via the Internet via any PC. The account of the administrator is the account managed by the online payment service 60, not the bank account.

The online payment service 60 can store payment code management information 60c to manage the payment code.

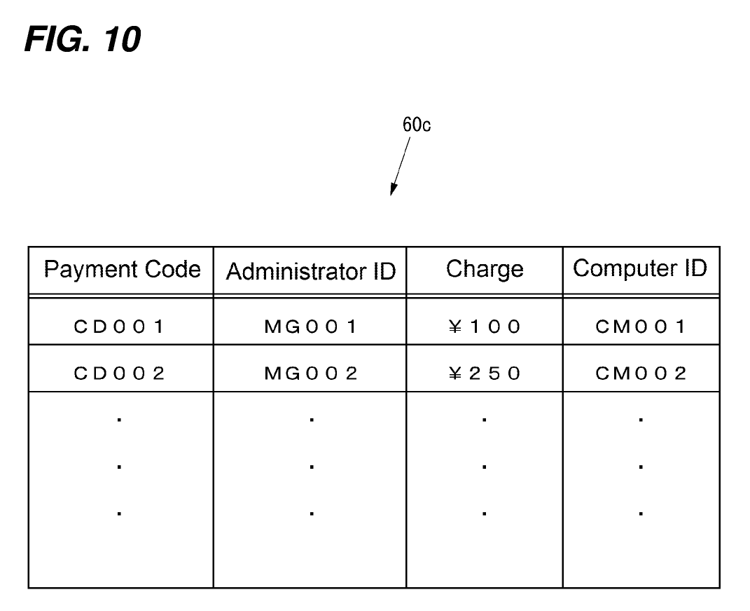

FIG. 10 illustrates the exemplary payment code management information 60c.

As illustrated in FIG. 10, the payment code management information 60c is information where the payment codes, the administrator IDs, the charges, and computer IDs as identification information of the computer, are matched.

The following describes operations of the document printing system 10.

First, a description will be given of the operation of the electronic device 30 when a document is stored in the document transmitting application 35b.

The user can instruct the electronic device 30 to store the document in the document transmitting application 35b via the operation unit 31. When the storage of the document is instructed, the document transmitting application 35b of the electronic device 30 stores the instructed document. Here, the document transmitting application 35b can store not only the document stored in the electronic device 30 but also documents that are accessible from the electronic device 30 and outside the electronic device 30, for example, documents stored in a USB flash drive and an SD card connected to the electronic device 30.

Next, a description will be given of the operation of the document printing system 10 when a new document 47b is stored in the MFP 40.

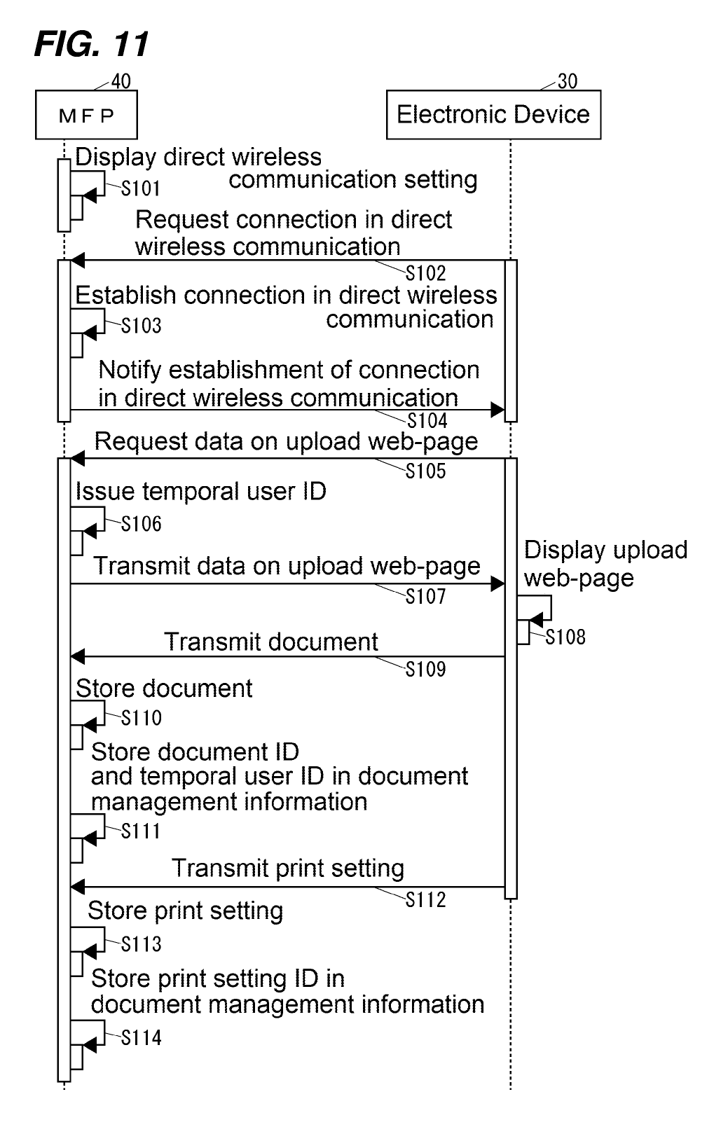

FIG. 11 illustrates the operation of the document printing system 10 when a new document 47b is stored in the MFP 40 (sequence diagram).

The user can instruct the MFP 40 to display a setting (hereinafter referred to as “a direct wireless communication setting”) for the direct wireless communication with the MFP 40 via the operation unit 41.

When the display of the direct wireless communication setting is instructed, as illustrated in FIG. 11, the wireless communication unit 48a of the MFP 40 displays the direct wireless communication setting on the display 42 (Step S101). Accordingly, the user can input the direct wireless communication setting displayed on the display 42 to the electronic device 30 via the operation unit 31 as a setting for the wireless communication.

When the direct wireless communication setting is input as the setting for the wireless communication, the control unit 35 of the electronic device 30 uses the input direct wireless communication setting to request the MFP 40 for connection in the direct wireless communication (Step S102). Accordingly, the wireless communication unit 48a of the MFP 40 establishes the connection with the electronic device 30 in the direct wireless communication (Step S103), and notifies the establishment of the connection in the direct wireless communication to the electronic device 30 (Step S104).

After this, the electronic device 30 and the MFP 40 can send and receive the information by the direct wireless communication.

After the establishment of the connection between the electronic device 30 and the MFP 40 in the direct wireless communication, the user can instruct a display of a web page (hereinafter referred to as “an upload web-page”) to upload the document via the operation unit 31.

When the display of the upload web-page is instructed, the web browser 35a of the electronic device 30 requests the MFP 40 for data on the upload web-page via the direct wireless communication (Step S105). Therefore, the document accepting unit 48b of the MFP 40 issues the temporal user ID (Step S106), and transmits the data on the upload web-page, which includes the temporal user ID issued in Step S106, to the electronic device 30 via the direct wireless communication (Step S107). Accordingly, the web browser 35a of the electronic device 30 displays the upload web-page on the display 32 based on the data on the upload web-page received from the MFP 40 (Step S108).

The user can instruct the upload of the document on the upload web-page displayed on the display 32 via the operation unit 31. Here, the user can instruct the upload of the document in the document transmitting application 35b on the upload web-page.

When the upload of the document in the document transmitting application 35b is instructed on the upload web-page, the web browser 35a of the electronic device 30 transmits the document to which the upload has been instructed to the MFP 40 via the direct wireless communication (Step S109). Therefore, the document accepting unit 48b of the MFP 40 accepts the document transmitted from the electronic device 30 to store in the storage unit 47 as the document 47b (Step S110), and matches a document ID of this document with the temporal user ID issued in Step S106 to store in the document management information 47d (Step S111).

After the upload of the document on the upload web-page displayed on the display 32, the user can instruct the print setting of this document on the upload web-page via the operation unit 31. Here, the upload web-page is configured to receive instruction for only the print setting supported by the printer driver 53a of the computer 50.

When the print setting of the document is instructed on the upload web-page, the web browser 35a of the electronic device 30 transmits this print setting to the MFP 40 via the direct wireless communication (Step S112). Therefore, the document accepting unit 48b of the MFP 40 accepts the print setting transmitted from the electronic device 30 as the print setting of the document accepted in Step S110 to store in the storage unit 47 as the print setting 47c (Step S113), and matches the print setting ID of this print setting with the document ID of the document as a target of this print setting and the temporal user ID to store in the document management information 47d (Step S114).

The user repeats the above-described operation to ensure storing a plurality of documents with respective print settings of the documents in the MFP 40 on the upload web-page displayed on the display 32 in Step S108.

The following describes the operation of the document printing system 10 until the MFP 40 to which an instruction of an execution of a document print job has been input displays a two-dimensional code.

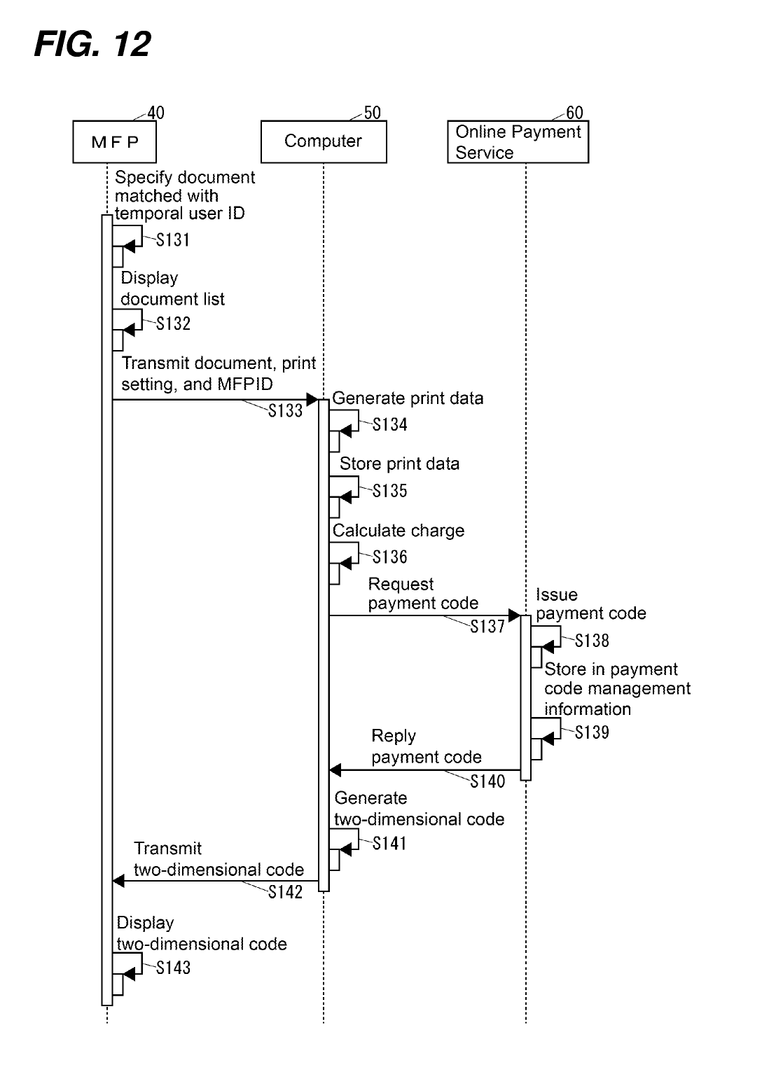

FIG. 12 illustrates the operation of the document printing system 10 until the MFP 40 to which the instruction of the execution of the document print job has been input displays the two-dimensional code.

After the document 47b is stored in the MFP 40, the user can login to the MFP 40 via the operation unit 41. Here, the user can login to the MFP 40 with the temporal user ID included on the upload web-page displayed on the display 32 in Step S108.

When the user has logged in with the temporal user ID via the operation unit 41, as illustrated in FIG. 12, the document designation accepting unit 48c of the MFP 40 specifies the documents 47b, which are matched with the temporal user ID of the user who has logged in and stored in the MFP 40, based on the document management information 47d (Step S131), and displays a list (hereinafter referred to as “a document list”) of the specified documents 47b on the display 42 (Step S132).

The user can choose the document 47b that the user desires to print from the document list displayed on the display 42 in Step S132 via the operation unit 41.

When the document 47b that the user desires to print is chosen via the operation unit 41, the document designation accepting unit 48c transmits the chosen document 47b, the print setting 47c matched with this document 47b in the document management information 47d, and the MFP ID of the MFP 40 to the computer 50 (Step S133).

Subsequently, the printer driver 53a of the computer 50 generates print data of this document 47b based on the document and the print setting transmitted from the MFP 40 in Step S133 (Step S134), and temporarily stores the generated print data in the storage unit 52 as the print data 52c (Step S135).

The print data 52c includes various information necessary for calculating the charge, for example, number-of-pages information indicative of the number of pages to be printed, number information indicative of the number of printed recording medium, recording medium size information indicative of a size of the printed recording medium, color information indicative of whether to execute any of a monochrome printing and a color printing, and double-side/single-side information indicative of whether to execute any of a duplex printing and a single-side printing.

The printer driver 53a determines the number-of-pages information and the number information based on, for example, the number of pages of the document and various print settings such as the setting of the number of copies included in the print setting of the document and the setting whether to execute any of the duplex printing and the single-side printing.

When an inconsistent setting is included between the print setting included in the document itself and the print setting transmitted with the document in Step S133, the printer driver 53a prioritizes the print setting transmitted with the document in Step S133. For example, when the print setting included in the document itself includes a setting of a color printing, and the print setting transmitted with the document in Step S133 includes a setting of a monochrome printing, the printer driver 53a employs the information indicating the monochrome printing as color information to include in the print data 52c.

After the process in Step S135, the charge calculator 53b of the computer 50 calculates the charge of a current document print job based on the number of pages of the document and the print setting transmitted from the MFP 40 in Step S133 and a specific calculation criterion (Step S136).

For example, when the print setting is set to the duplex printing, the print job is executed on the recording medium of a half of the number of pages of the document 47b per copy. The charge calculator 53b may reflect the number on the charge.

When the print setting is set to a plurality of number of copies, the print job is executed on printing surfaces by the number obtained by multiplying the number of printing surfaces of the recording medium for one copy of the document 47b by the number of copies. The charge calculator 53b may reflect the number of the printing surfaces on the charge.

After the process of Step S136, the payment communication unit 53c of the computer 50 requests a payment code of the charge calculated in Step S136 to the online payment service 60 (Step S137). Here, the payment communication unit 53c includes the administrator ID, which is matched with the MFP ID transmitted from the MFP 40 with the document in Step S133 in the MFP management information 52d, and the computer ID of the computer 50 into the request in Step S137.

Accordingly, the online payment service 60 issues the payment code corresponding to the request in Step S137 (Step S138), subsequently matches the issued payment code with the administrator ID, the charge, and the computer ID, which are included in the request in Step S137, to store in the payment code management information 60c (Step S139), and replies the issued payment code to the computer 50 (Step S140).

The payment communication unit 53c of the computer 50 generates a two-dimensional code such as a QR code (registered trademark) that indicates the payment code replied from the online payment service 60 in Step S140 (Step S141). The payment communication unit 53c matches the payment code replied from the online payment service 60 in Step S140 with the MFP ID transmitted from the MFP 40 in Step S133 and the print data ID of the print data generated in Step S134, so as to store in the payment code management information 52e.

Next, the payment communication unit 53c transmits the two-dimensional code generated in Step S141 to the MFP 40 (Step S142).

Accordingly, the payment code notification unit 48d of the MFP 40 displays the two-dimensional code transmitted from the computer 50 in Step S142 on the display 42 (Step S143).

The following describes the operation of the document printing system 10 from when the user terminal 20 reads the two-dimensional code until the MFP 40 terminates the execution of the document print job.

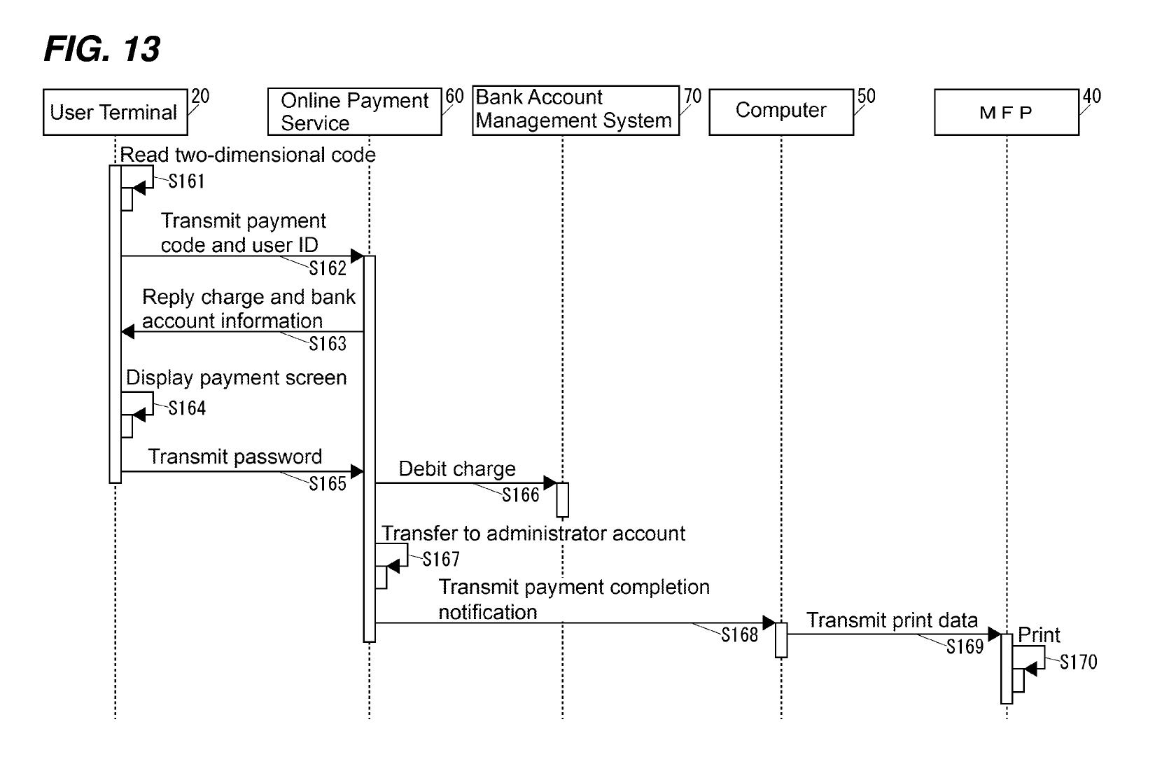

FIG. 13 illustrates the operation of the document printing system 10 from when the user terminal 20 reads the two-dimensional code until the MFP 40 terminates the execution of the document print job.

The user can operate the user terminal 20 so as to cause the capturing unit 23 of the user terminal 20 to read the two-dimensional code displayed on the display 42 of the MFP 40 in Step S143. When the user terminal 20 is operated so as to cause the capturing unit 23 to read the two-dimensional code displayed on the display 42, as illustrated in FIG. 13, the payment instruction unit 26a of the user terminal 20 reads the two-dimensional code displayed on the display 42 by the capturing unit 23 (Step S161).

Subsequently, the payment instruction unit 26a interprets the two-dimensional code read in Step S161, and transmits the payment code indicated by the two-dimensional code and the user ID of the user logged in to the user terminal 20 to the online payment service 60 (Step S162).

Accordingly, the online payment service 60 replies the charge, matched with the payment code in the payment code management information 60c, and the information on the bank account, associated with the user ID in the user bank account information 60a, to the user terminal 20 based on the payment code and the user ID transmitted from the user terminal 20 in Step S162 (Step S163).

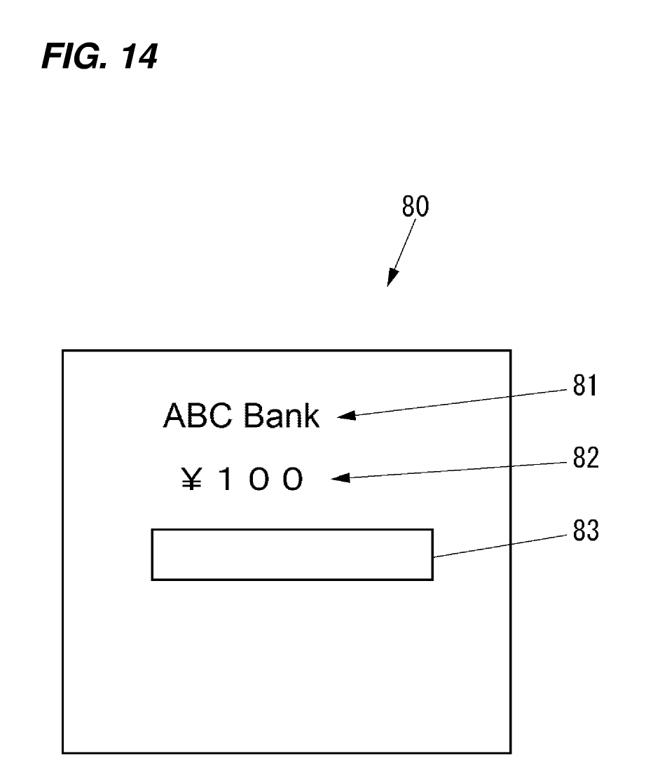

When the charge and the information on the bank account are transmitted from the online payment service 60, the payment instruction unit 26a of the user terminal 20 displays a payment screen 80 (see FIG. 14) to pay for the charge on the display 22 (Step S164).

FIG. 14 illustrates an exemplary payment screen 80.

As illustrated in FIG. 14, the payment screen 80 includes a text 81, a text 82, and a text box 83. The text 81 indicates the information on the bank account transmitted from the online payment service 60. The text 82 indicates the charge transmitted from the online payment service 60. To the text box 83, a password for the bank account, that is, a password to permit a debit from the bank account by the bank account management system 70 is input.

FIG. 14 shows a name of a bank as the information on the bank account displayed in the payment screen 80. However, as the information on the bank account, the payment screen 80 may display the information other than the name of the bank in addition to the name of the bank or instead of the name of the bank. At Step S163, it is only necessary that only the information displayed in the payment screen 80 is replied among the information on the bank account.

As illustrated in FIG. 13, when the password for the bank account is input to the text box 83, the payment instruction unit 26a transmits the input password to the online payment service 60 (Step S165).

Accordingly, only when the password transmitted from the user terminal 20 at Step S165 is correct, the online payment service 60 debits the charge, matched with the payment code transmitted from the user terminal 20 at Step S162 in the payment code management information 60c, from the bank account, associated with the user ID transmitted from the user terminal 20 at Step S162 in the user bank account information 60a, among the bank accounts managed by the bank account management system 70 (Step S166).

Next, the online payment service 60 transfers the charge debited at Step S166 to the account associated with the administrator ID, which is matched with the payment code transmitted from the user terminal 20 at Step S162 in the payment code management information 60c, in the administrator account information 60b (Step S167).

Next, the online payment service 60 transmits a payment completion notification indicative of the completion of the payment for the charge and the payment code transmitted from the user terminal 20 at Step S162 to the computer 50 with the computer ID matched with this payment code in the payment code management information 60c (Step S168).

When the payment completion notification is transmitted from the online payment service 60 at Step S168, the payment communication unit 53c in the computer 50 transmits the print data 52c with the print data ID, which is matched with the payment code transmitted with the payment completion notification from the online payment service 60 in Step S168 in the payment code management information 52e, among the print data 52c stored in the storage unit 52 to the MFP 40 with the MFP ID matched with this payment code in the payment code management information 52e (Step S169).

When the print data is transmitted from the computer 50 at Step S169, the document printing unit 48e in the MFP 40 executes the print job by the printer 44 based on the print data (Step S170).

As described above, in the document printing system 10, accurate charge based on the number of pages and the print setting of the document is paid (Steps S165 to S167), and subsequently, the print job is executed based on the print data of this document (Step S170). Then, the execution of the document print job as “to execute printing of document” is not halted in its course due to a delay of payment for the charge, thus ensuring the improvement of convenience.

Since the document printing system 10 uses the online payment service 60, not a coin vendor, to pay for the charge, the charge is directly transferred from the bank account of the user of the MFP 40 to the account of the administrator of the MFP 40. This eliminates the need for acquisition work of the charge from the coin vendor, thus ensuring reduction in labor costs and safety reception of the charge.

Since the document printing system 10 uses the online payment service 60, not the coin vendor, to pay for the charge, the document printing system 10 can be easily introduced to countries where the coin vendors are not used so much.

Since the document printing system 10 uses the web browser 35a to transmit the document via the document transmitting application 35b, the document can be transmitted to the MFP 40 by the web browser 35a even if a specification of the web browser 35a of the electronic device 30 is a specification that requires some sort of application via which a file is transmitted to the outside of the electronic device 30.

In the document printing system 10, the MFP 40 accepts the document from the external electronic device 30 via the direct wireless communication (Steps S109 and S110). Then, even if the MFP 40 is not connected to the network, such as a LAN, to which a plurality of external electronic devices connect, the MFP 40 can accept the document. Accordingly, the document printing system 10 can prevent the MFP 40 from executing a print job that corresponds to an instruction via the network, such as a LAN, to which the plurality of external electronic devices connect, for example, a print job of the document unrelated to the payment for the charge using the online payment service 60.

In the document printing system 10, the printer driver 53a of the computer 50 generates the print data based on the print setting accepted by the document accepting unit 48b of the MFP 40. This ensures printing the document 47b stored in the MFP 40 with the print setting designated by the user.

The document printing system 10 can print the document transmitted from the electronic device 30 to the MFP 40 by the MFP 40 based on the print setting designated from the electronic device 30 even if a printer driver for the MFP 40 is not installed onto the electronic device 30.

In the document printing system 10, the charge calculator 53b of the computer 50 calculates the charge based on the print setting accepted by the document accepting unit 48b of the MFP 40 in Step S133 (Step S136). With this configuration, the document printing system 10 executes the print job based on the print data of the document after an accurate payment for the charge based on the print setting of this document, thus ensuring the improvement of convenience.

In the MFP 40 of the document printing system 10, the document accepting unit 48b notifies the temporal user ID as the identification information matched with the accepted document (Step S107), and the payment code notification unit 48d notifies the payment code of the document which is matched with the temporal user ID and accepted the designation by document designation accepting unit 48c (Step S143). With this configuration, the document printing system 10 notifies only the payment code of the document matched with the temporal user ID designated by the user. Then, the document printing system 10 can print only the document recognized by the user, thus ensuring the improvement of convenience.

In the document printing system 10, the MFP 40 notifies the payment code by displaying on the display 42 (Step S143). Then, even if the user terminal 20 and the MFP 40 cannot mutually communicate, the payment code displayed on the display 42 of the MFP 40 can be used to pay for the charge by the user terminal 20 via the online payment service 60.

In the document printing system 10, the payment code is compactly displayed as the two-dimensional code on the display 42 of the MFP 40. Then, the payment code is easily captured by the capturing unit 23 of the user terminal 20, thus ensuring the improvement of convenience. The document printing system 10 may display the payment code on the display 42 with a method where it is difficult for the capturing unit 23 of the user terminal 20 to capture the payment code compared with the two-dimensional code, for example, a character string and a one-dimensional code.

In the document printing system 10, the payment code displayed on the display 42 is obtained by capturing by the capturing unit 23, thus eliminating the need for manually inputting the payment code displayed on the display 42 of the MFP 40 to the user terminal 20 by the user of the user terminal 20. Accordingly, the document printing system 10 ensures the improvement of convenience. When the document printing system 10 displays the payment code on the display 42 with not the two-dimensional code but a method, such as a character string, understandable for the user of the user terminal 20, the document printing system 10 may have a configuration where the payment code displayed on the display 42 of the MFP 40 is manually input to the user terminal 20 by the user of the user terminal 20.

In the embodiment, the document printing system 10 uses the account managed by the online payment service 60 as the account of the administrator of the MFP 40. However, the document printing system 10 may have a configuration that uses the bank account, not the account managed by the online payment service 60, as the account of the administrator of the MFP 40.

In the embodiment, the document printing system 10 uses the bank account as the account of the user of the MFP 40. However, the document printing system 10 may have a configuration that uses the account managed by the online payment service 60, not the bank account, as the account of the user of the MFP 40.

In the embodiment, the document printing system 10 includes the MFP 40 that manages the document transmitted from the electronic device 30 to the MFP 40. However, the document printing system 10 may include the computer 50 that manages the document transmitted from the electronic device 30 to the MFP 40.

The document printing system 10 may have a configuration where the MFP 40 achieves at least a part of the above-described functions of the computer 50 by executing the document print program 47a. For example, the document printing system 10 may have a configuration where the MFP 40 achieves the function corresponding to the printer driver 53a and the charge calculator 53b of the computer 50. In a configuration where the MFP 40 achieves every above-described function of the computer 50, the document printing system 10 may omit the computer 50.

In the embodiment, the document printing system 10 includes the user terminal 20 and the electronic device 30 as separate devices. However, in the document printing system 10, the user terminal 20 and the electronic device 30 may be achieved by one device.

While the image forming apparatus of the disclosure is the MFP in the embodiment, the image forming apparatus may be an image forming apparatus other than the MFP, for example, a printer-only machine.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A document printing system comprising:
an image forming apparatus that includes
a print device, and
a document accepting unit that accepts a document via a web page;
an electronic device that includes a web browser to display the web page;
a print-data generating unit that generates print data of the document accepted by the document accepting unit;
a charge calculator that calculates a charge based on the document accepted by the document accepting unit; and
a payment code notification unit that notifies a payment code issued by an online payment service to the charge calculated by the charge calculator; wherein
the image forming apparatus includes a document printing unit that executes a print job with the print device based on the print data when the charge has been paid via the online payment service using the payment code notified by the payment code notification unit,
the electronic device includes a document transmitting application to transmit the document, and
the web browser transmits the document to the image forming apparatus via the document transmitting application.

2. The document printing system according to claim 1, wherein:
the image forming apparatus includes a wireless communication unit configured to execute direct wireless communication with the electronic device without being via another communication device; and
the document accepting unit accepts the document via the wireless communication executed by the wireless communication unit.

3. The document printing system according to claim 1, wherein:
the document accepting unit accepts a print setting of the document; and
the print-data generating unit generates the print data based on the print setting accepted by the document accepting unit.

4. The document printing system according to claim 3, wherein the charge calculator calculates the charge based on the print setting accepted by the document accepting unit.

5. The document printing system according to claim 1, wherein:
the document accepting unit notifies identification information matched with the accepted document;
the image forming apparatus includes a document designation accepting unit that accepts a designation of the document matched with the identification information; and
the payment code notification unit notifies the payment code of the document where the designation has been accepted by the document designation accepting unit.

6. The document printing system according to claim 1, wherein:
the image forming apparatus includes a display device; and
the payment code notification unit notifies the payment code by displaying on the display device.

7. The document printing system according to claim 6, comprising:
a user terminal to pay the charge via the online payment service using the payment code notified by the payment code notification unit; wherein
the user terminal includes a capturing device and obtains the payment code displayed on the display device by capturing with the capturing device.

8. The document printing system according to claim 7, wherein the payment code notification unit displays the payment code as a two-dimensional code on the display device.
